(19) United States
(12) Patent Application Publication
(10) Pub. No.: US 2023/0059305 A1
(43) Pub. Date: Feb. 23, 2023

(54) SLIDING GUIDE SHOE FOR AN ELEVATOR AND METHOD FOR PRODUCING A SLIDING GUIDE SHOE

(71) Applicant: Inventio AG, Hergiswil (CH)

(72) Inventor: Volker Zapf, Obernau (CH)

(21) Appl. No.: 18/046,532

(22) Filed: Oct. 14, 2022

Related U.S. Application Data
(62) Division of application No. 15/733,625, filed on Sep. 18, 2020.

(30) Foreign Application Priority Data
Jun. 28, 2018 (EP) 18180422.0

(51) Int. Cl. B66B 7/04; B29C 45/14

(52) U.S. Cl. CPC B66B 7/047; B29C 45/14467; B66B 7/048; B29L 2031/721

(57) ABSTRACT

A guide shoe for an elevator is formed entirely of plastic materials and includes a guide shoe housing, a damping element and a guide element that are firmly bonded to one another and form a one-piece composite structure. The composite structure is produced by a three-component injection molding process.

### CROSS-REFERENCE TO RELATED APPLICATIONS

This application is a divisional of the co-pending U.S. patent application Ser. No. 15/733,625 filed Sep. 18, 2020, which application is a 371 of International application PCT/EP2019/066967 filed Jun. 26, 2019 that claims priority from EP application 18180422.0 filed Jun. 28, 2018.

### FIELD

The invention relates to a sliding guide shoe for an elevator for conveying persons or goods and to a method for producing a sliding guide shoe for an elevator.

### BACKGROUND

Sliding guide shoes are frequently used to guide elevator cars. Elevator systems in buildings usually have a vertical elevator shaft in which in each case one guide rail is arranged on opposite shaft walls. Sliding guide shoes arranged on the elevator car have sliding surfaces facing the guide rail, which slide along the guide rail with little play. Well-known and common are sliding guide shoes which have inserts with sliding surfaces, wherein the inserts are often configured as profiles with a U-shaped cross-section. Since the inserts wear out over time, worn or old sliding inserts must be replaced. Known from DE 203 15 915 U1 is, for example, a sliding guide shoe with a guide shoe housing and an insert inserted in the guide shoe housing, wherein the insert is configured in two parts. The insert consists of a carrier element and a sliding element. The sliding element can be replaced, wherein, however, the entire sliding guide shoe must first be removed after initial commissioning of the elevator. In practice, it has been shown that even after the sliding guide shoe has been dismantled from the car, the sliding element inserted into a pocket-like recess in the carrier element, which recess is open towards the front, is difficult to remove from the carrier element and inserting it can also be difficult. With special sliding guide shoes, as known from EP 1 880 968 A1 or EP 2 771 268 A1 (see WO 2013/060583 A1), it is possible to remove the insert completely or partially from the sliding guide shoe by pulling it out sideways in a longitudinal direction along the guide rails without having to completely dismantle the guide shoe. The known sliding guide shoes are comparatively expensive and complicated to produce.

### SUMMARY

It is therefore an object of the present invention to avoid the disadvantages of the prior art and in particular to create a sliding guide shoe of the aforementioned type which can be produced in a simple and cost-effective manner.

According to the invention, this object is achieved with the sliding guide shoe for an elevator for conveying persons or goods that comprises a guide shoe housing and a sliding element arranged in the guide shoe housing for guiding the elevator car along a guide rail, or a sliding element arranged in the guide shoe housing for guiding a counterweight along a guide rail. The fact that the guide shoe housing and the sliding element form a composite structure creates a compact single-use sliding guide shoe. A composite structure is understood here to be a structure made up of a plurality of components or elements, in which the components or elements are permanently connected to each other and are usually connected without the use of mechanical fasteners (such as screws or other detachable fasteners) to hold or secure the components together. The components or elements thus connected to each other form a unit, wherein separating or detaching individual components or elements from the integral unit is accordingly not provided. The composite structure can be formed as one piece or multiple pieces.

This configuration results in a number of advantages. For example, the configuration according to the invention of the sliding guide shoe makes it possible to produce the sliding guide shoe in a simple and cost-effective manner. In particular, the mass production of the sliding guide shoe is considerably simplified. Since no mechanical fastening elements are required to hold or secure the components together, the sliding guide shoe can be manufactured in just a few process steps. There is no need for time-consuming assembly; assembly efforts for assembling individual elements or components are eliminated. Since the guide shoe housing and the sliding element are securely and captively connected to each other, there are also advantages in terms of handling the sliding guide shoe. The effort required for mounting the sliding guide shoe to the elevator car or counterweight and to remove it from the elevator car or counterweight is greatly reduced.

The guide shoe housing serves, on the one hand, to hold the sliding element and, on the other hand, to connect it to the elevator car. For the connection to the elevator car, the guide shoe housing can comprise, for example, openings through which fastening screws can be inserted, with which the sliding guide shoe can be screwed via the guide shoe housing to the car or to a bracket as an intermediate element to establish a connection to the car. The sliding element is that element that serves for guiding the elevator car along a guide rail extending in the direction of travel or longitudinal direction. For this purpose, the sliding element may have sliding surfaces or areas which, when the sliding guide shoe is installed in the elevator and ready for use, slide along the guide rail with little play during car travel.

In a preferred embodiment, the guide shoe housing and the sliding element are made of plastic materials and preferably made of different plastic materials. Guide shoe housing and sliding element made of plastic materials result in an advantageous one-piece or multi-piece composite structure. This composite structure is particularly suitable as a single-use or disposable component. Once it has reached its service life, it can be disposed of quickly and easily. The plastic sliding guide shoe is particularly easy to produce and is available in large quantities and at low cost; the appropriate plastic materials can be selected depending on the required properties and requirements.

To optimize travel comfort, it can be advantageous if a damping element is arranged between the guide shoe housing and the sliding element. Through appropriate material selection, structural design or shaping, the damping element can have damping properties, which ensures a low-vibration and low-noise travel of the car.

It may be particularly preferred if the sliding guide shoe is a composite structure consisting entirely of plastic materials, wherein the guide shoe housing, damping element and sliding element are preferably made of different plastic materials. Mixed forms containing plastics and metals could also be of interest, depending on the intended use.

The plastic material for the guide shoe housing is preferably a high-strength plastic material, for example a thermoplastic or a thermoset. The guide shoe housing can be made of polyethylene (PE), polypropylene (PP), polyamide (PA), polyimide (PI), polystyrene (PS), polyurethane (PUR) or polyoxymethylene (POM). Abbreviations are generally known and common for plastic materials, which is why for the sake of simplicity, abbreviations or letter symbols for specific plastic materials are used below. PES, PEEK or TPEs can also be considered for the guide shoe housing. It can be particularly advantageous if a fiber-reinforced plastic material is used for the guide shoe housing. The plastic for the guide shoe housing can include glass fibers, carbon fibers and/or aramid fibers, for example.

For the damping element, for example, an elastic plastic material can be used, in particular a thermoplastic elastomer (TPE) or a plastic material made of cross-linked elastomers. The damping element can be produced from SBR, TUR, EPDM, NBR, NR, for example. The damping element could consist of an elastomer alloy. By adjusting the mixing ratios and adding additives, damping elements with the desired damping behavior can be obtained.

The sliding element is preferably produced from a plastic material which, with regard to the sliding function, is characterized by a low coefficient of friction. In addition to good sliding properties, the plastic material for the sliding element should preferably also have sufficiently high strength, rigidity and hardness. The sliding element can be produced from POM or UHMW-PE, for example. To ensure safe and faultless operation of the elevator, the guide rails are usually wetted with oil or another lubricant. When sliding guide shoes with sliding elements made of POM or UHMW-PE are used, lubrication of the guide rails could also be eliminated, if desired, due to the good dry-running properties of these plastics or, in special situations, lubrication could be turned off at least temporarily. Sliding elements with particularly good sliding properties also ensure jerk-free starting of the elevator car and almost noiseless operation during a car travel.

The use and combination of such plastics also has the advantage that they can withstand the material requirements of the functions of the respective components (guide shoe housing, damping element, sliding element) despite their low cost, thus increasing the service life of the sliding guide shoe.

For example, the plastic material for the guide shoe housing could be POM, preferably fiber-reinforced POM, for the damping element TPE and for the sliding element POM. For the guide shoe housing and the sliding element, therefore, similar plastic materials (i.e. POM) can be used, wherein the respective plastic materials are adapted to the intended function by selecting the production method and degree of polymerization and by adding additives, if necessary.

It is particularly advantageous if the sliding guide shoe is a composite structure produced by a two-component or three-component injection molding process. The sliding guide shoe produced by the 2-component injection molding process mentioned above consists of a guide shoe housing and a sliding element. In this case, the guide shoe housing can therefore be connected directly to the sliding element. The sliding guide shoe produced by the three-component injection molding process concerns the sliding guide shoe constructed from three components consisting of guide shoe housing, sliding element and damping element.

One advantage of the sliding guide shoe, which is a composite structure produced by a two-component or three-component injection molding process, is, for example, that no special assembly work is required compared to conventional sliding guide shoes, which are constructed from separate components which are prefabricated in each case and require a comparatively large amount of assembly work to assemble the sliding guide shoe. Such a sliding guide shoe can be mass-produced at low cost and in constant quality. The injection molding machines used for this purpose are suitable for particularly efficient automated production. Operating parameters can be optimally adjusted. Additional connecting means with which the individual components have to be connected to each other can be dispensed with.

Of course, other production methods are also conceivable. For example, the sliding guide shoe could be produced by means of a 3D printer.

The guide shoe housing, the sliding element and optionally the damping element can be connected to each other in a non-positive, positive and/or firmly bonded manner. These types of connection can ensure in a simple manner that no additional mechanical connecting elements, such as screws, are required.

A particularly compact sliding guide shoe formed in one piece can be achieved if the guide shoe housing, the sliding element and optionally the damping element—if present—are connected to each other in a firmly bonded manner. It is conceivable, for example, to first prefabricate the respective components, i.e. the guide shoe housing, the sliding element and optionally the damping element, and then to assemble the separate parts or components and connect them to one another by bonding. The individual components could also be connected to each other by means of plastic welding.

The guide shoe housing, the sliding element and optionally the damping element can be connected to each other by means of a chemical bonding agent or can be thermally bonded.

For example, if the sliding guide shoe is a composite structure produced by a two-component or three-component injection molding process, it may be difficult, however, to ensure a sufficiently strong bond between the components, depending on the plastic materials used for the individual components (guide shoe housing, sliding element, damping element). For example, plastic materials often have different processing temperatures and processing shrinkages such that cross-linking between the plastic materials during the production process cannot or can hardly occur; shrinkage can result in a separating gap between the components. In order to counteract this effect and still ensure a good connection, the respective components can be connected to each other by means of positive locking means. A sliding guide shoe, in which the guide shoe housing, the sliding element and optionally the damping element are positively connected to each other, results in a compact and stable multi-piece composite structure.

The guide shoe housing, the sliding element and, where appropriate, the damping element can each have positive locking means which are accommodated in and engaging in complementary positive locking means for the positive connection of guide shoe housing and sliding element or, respectively, of guide shoe housing and damping element on the one hand and damping element and sliding element on the other.

The guide shoe housing, at least with regard to the interface to the sliding element or (if present) to the damping element, is preferably a monolithic element consisting of the same material. Accordingly, the positive locking means associated with the guide shoe housing would also be molded onto the guide shoe housing and monolithically connected thereto. Separate parts, such as connecting elements for lubricating the guide rail, could be attached to this one-piece guide shoe housing.

A secure positive connection can be achieved if, for protection at the edge, the guide shoe housing comprises a circumferential shoulder contour in which the sliding element or, where appropriate, the damping element is enclosed.

Additionally or alternatively, the sliding element can comprise a circumferential positive locking collar which engages in a positive locking groove of the sliding element or optionally in a positive locking groove of the damping element. An outer edge of the positive locking groove can form the aforementioned circumferential shoulder contour in which the sliding element or, where appropriate, the damping element is enclosed.

A further aspect of the invention relates to a method for producing a sliding guide shoe for an elevator, in particular a method for producing the previously described sliding guide shoe. The sliding guide shoe comprises at least two components, namely a guide shoe housing and a sliding element for guiding an elevator car or a counterweight along a guide rail. However, the sliding guide shoe may also comprise a third component, namely a damping element arranged between the guide shoe housing and the sliding element. The method according to the invention is characterized in that for forming a composite structure, one of the components is produced on the other component in a primary forming process, the guide shoe housing being one of the components involved in the forming process. The second component can thus be produced on the first component in a primary forming process. In this way, the two components can be connected to each other (directly or indirectly) without any assembly activity. Primary forming processes can be, for example, injection molding or compression molding (e.g. compression molding, impact extrusion, transfer molding). In particular for small series or for the production of special designs for the guide shoe housing, it is also conceivable to produce one of the components on top of the other component by means of additive manufacturing. Additive manufacturing can be carried out without tools. For additive manufacturing of the sliding guide shoe, 3D printing technologies, such as fused layer process, stereolithography, digital light processing, laser sintering, laser melting or multi-jet fusion technology can be used. It can be particularly advantageous if each of the additional components is produced on the other component(s) in each case in a primary forming process.

If the guide shoe housing is produced using, for example, an injection molding process, a damping element can be injection molded onto the guide shoe housing. Thereafter, the sliding element can also be injection molded onto a blank comprising the guide shoe housing and the damping element. The sliding guide shoe produced in this way was thus produced using a three-component injection molding process. For simpler sliding guide shoes, i.e. sliding guide shoes only including guide shoe housing and sliding element or, respectively, sliding guide shoes without damping element, the sliding element can be injection molded directly onto the guide shoe housing. The latter sliding guide shoe is thus produced using a two-component injection molding process. If the guide shoe housing is a prefabricated component made of metal, e.g. steel or a metal casting, it can also be advantageous if the other components, thus the sliding element and optionally the damping element, are injection molded onto the guide shoe housing as previously described.

In the aforementioned method, the sliding guide shoe is produced from the outside to the inside. Starting from the outermost component, the guide shoe housing, an inner component, the sliding element or the damping element, is produced. The method can also be carried out in the opposite direction. The starting point here is the innermost component, the sliding element. An outer component, the guide shoe housing or the damping element, is created on the sliding element fabricated first. The alternative production method therefore comprises the following steps: The sliding element is produced in particular by an injection molding process, thereafter the damping element is injected onto the sliding element by an injection molding process and finally the guide shoe housing is injection molded onto a blank by an injection molding process, the blank comprising sliding element and damping element. The sliding guide shoe produced in such a manner was thus produced by means of a three-component injection molding process. For the sliding guide shoe produced by means of a two-component injection molding process, the guide shoe housing is injection molded directly onto the sliding element by means of an injection molding process after the sliding element has been manufactured.

However, instead of the injection molding process using injection molding, it would also be possible to integrally cast the respective materials for producing the respective components.

A further aspect of the invention then relates to a sliding guide shoe for an elevator, in particular a sliding guide shoe according to the previous description, wherein the sliding guide shoe can be obtained by a method comprising the following steps: providing a mold for producing a guide shoe housing, injecting a first plastic material into the mold for producing the guide shoe housing, and producing a composite structure by injection molding a second plastic material onto the guide shoe housing, wherein the second plastic is provided for forming a sliding element or a damping element. Injection molding the second plastic material can take place when the blank for the guide shoe housing is still hot. However, it would also be conceivable that the blank has already cooled down or is at best still warm and only then injection molding of the second plastic material is carried out. For a firm connection, chemical bonding agents can be used which are applied to the cooled blank, if needed.

The first plastic material can be a high-strength plastic, selected, for example, from the group of PE, PP, PA, PS, PES, PUR, POM, PEEK or TPEs.

Particularly preferably, fiber-reinforced plastic is used here, which makes it possible to create a guide shoe housing with particularly high rigidity and strength and dimensional stability. The second plastic material can be a stiff plastic (e.g. POM or UHMW-PE) with a low coefficient of friction, which forms a sliding element for guiding an elevator car along a guide rail.

However, the second plastic material can also be a comparatively elastic plastic material, such as TPE, which forms a damping element for the sliding guide shoe. A third plastic material is injection molded onto this second plastic material, whereby a sliding guide shoe with guide shoe housing, damping element and sliding element, thus a sliding guide shoe consisting of or constructed from three components can be obtained. The third plastic material, which is provided for forming the sliding element, can therefore be the already mentioned stiff plastic material (e.g. POM or UHMW-PE) with a low coefficient of friction.

As an alternative, the sliding guide shoe can also be obtained with a method comprising the following steps: providing a mold for producing a sliding element, injecting a first plastic material into the mold for producing the sliding element, producing a composite structure by injection molding a second plastic material onto the sliding element. In this variant, the first plastic material would be a stiff plastic material (e.g. POM or UHMW-PE) with a low coefficient of friction. To create a two-component guide shoe, the second plastic material can be the high-strength plastic material, wherein particularly preferably a fiber-reinforced plastic material is used, whereby a guide shoe housing with high rigidity, strength and dimensional stability can be created. For a guide shoe comprising three components, a comparatively elastic plastic material, such as TPE, is used as the second plastic material, which second plastic material forms the damping element for the sliding guide shoe. Finally, the third plastic is injection molded onto the second plastic material forming the sliding element.

As an alternative, the sliding guide shoe can also be obtained with a method which differs from the previously described method only in the different order in the production of the individual components. This sliding guide shoe can therefore be obtained by a method comprising the following steps: providing a mold for producing the sliding element, injecting a first plastic material into the mold for producing the sliding element, producing a composite structure by injection molding a second plastic material onto the sliding element for forming either the guide shoe housing or the damping element. In the latter case, thus when the damping element has been formed by injection molding the second plastic material onto the sliding element, a composite structure consisting of three components is produced by injection molding a third plastic material onto the damping element for forming the guide shoe housing.

### DESCRIPTION OF THE DRAWINGS

Further advantages and individual features are apparent from the following description of exemplary embodiments and from the drawings. In the figures:

FIG. 1 shows a simplified top view of an elevator with an elevator car guided on guide rails via sliding guide shoes according to the invention,

FIG. 2 shows a sectional view of a sliding guide shoe according to the invention comprising two components,

FIG. 3 shows a sectional view of a variant of the sliding guide shoe according to FIG. 2, wherein the sliding guide shoe comprises three components,

FIG. 4 shows a perspective view of a sliding guide shoe according to the invention comprising three components,

FIG. 5 shows a method according to the invention for producing a sliding guide shoe in a highly simplified illustration and in a sectional view,

FIG. 6 shows an alternative sliding guide shoe to the exemplary embodiment shown in FIG. 3,

FIG. 7 shows a sectional view of another exemplary embodiment of a sliding guide shoe,

FIG. 8 shows a sectional view of an exemplary embodiment of a sliding guide shoe with positive connection between sliding element and guide shoe housing,

FIG. 9 shows a perspective view with partial sections of a two-component sliding guide shoe with half-sections,

FIG. 10 shows a perspective view of the sliding element for the sliding guide shoe from FIG. 9, and

FIG. 11 shows a variant of the sliding guide shoe according to FIG. 9, wherein the sliding guide shoe comprises three components.

### DETAILED DESCRIPTION

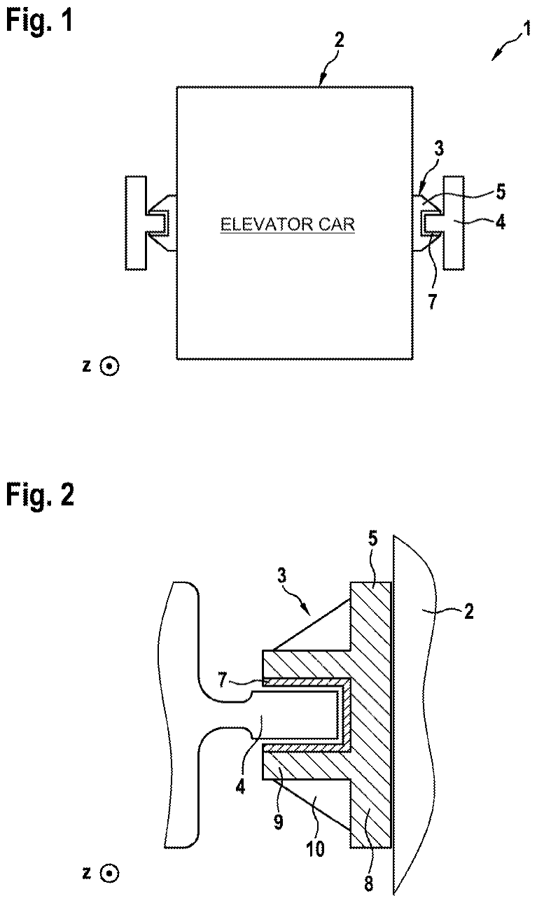

FIG. 1 shows an elevator, collectively denoted by 1, with an elevator car 2, which is guided vertically between two guide rails 4 and can be moved up and down in the z-direction in an elevator shaft which is not shown. The linear guide with the guide rail 4 in the present example is formed by a T-profile extending in the longitudinal z-direction. At least one sliding guide shoe 3 is arranged on each side of the car 2 for guiding the car 2. For optimum guidance, elevator cars generally have four (two on each side) or more sliding guide shoes. Likewise, a counterweight (not shown) connected to the car by suspension means in the form of ropes or belts may have identically formed sliding guide shoes (not shown here) for guiding the counterweight on counterweight guide rails.

The sliding guide shoe 3 substantially consists in a manner known per se of the following two components: a guide shoe housing 5 and a sliding element 7. The guide shoe housing 5 serves, on the one hand, to hold the sliding element 7 and, on the other hand, to connect it to the elevator car. The guide shoe housing 5 can be connected directly to the car 2 as shown in FIG. 1 or can be attached to a bracket (not shown), the bracket forming a connecting element to the car. The sliding element 7 is arranged in a channel-like receptacle in the guide shoe housing 5. The sliding element 7 consists of a material and/or surfaces with good sliding properties facing the guide rail 4, so that a good and low-wear guidance of the car 2 on the guide rails 4 is made possible. The sliding element 7 in the present case is obviously U-shaped.

A special feature of the sliding guide shoe 3 according to the invention is that the guide shoe housing 5 and the sliding element 7 together form a one-piece composite structure. Guide shoe housing 5 and sliding element 7 are thus captively connected to each other. This results in an advantageous compact sliding guide shoe that can be used as a single-use or disposable component. Since such a sliding guide shoe 3 can be produced in a simple and cost-effective manner, the sliding guide shoe as a whole can be disposed of when it reaches the end of its service life and can be replaced by a new sliding guide shoe.

FIG. 2 shows a sliding guide shoe 3 comprising two components in an enlarged view. The guide shoe housing 5 has a base portion 8 which is attached directly or indirectly to the car 2. The guide shoe housing 5 also has two support portions 9 projecting at right angles from the base section 8. The support portions 9 define a channel-like receptacle in which the U-shaped sliding element is arranged. For reinforcing, ribs 10 are provided, each of which supports the support portions 9 towards the base section 8. The sliding element 7 is firmly bonded to the guide shoe housing 5 and thus forms a common molded body therewith.

It is particularly advantageous if the sliding guide shoe 3 is manufactured in a two-component injection molding process. The guide shoe housing 5 can be an injection-molded part made of a first plastic material, onto which a second plastic material for producing the sliding element 7 is injected molded. However, it is also conceivable to provide a metal guide shoe housing 5 onto which a plastic material for producing the sliding element 7 is injection molded by an injection molding process. It would even be possible to first configure the two components, thus the guide shoe housing 5 and the sliding element 7, as separate parts and to connect them to each other by gluing.

The guide shoe housing 5 can be made of a high-strength plastic material, for example a thermoplastic. This plastic material can be easily injection molded. The plastic material can be, for example, PE, PP, PA, PS, PES, PUR, POM, PEEK or TPE. For a stable, rigid housing, it is preferred to use a fiber-reinforced plastic material, for example, a glass fiber-reinforced plastic material for the guide shoe housing 5. For example, the guide shoe housing 5 can be made of fiber-reinforced POM, a high degree of rigidity, strength and hardness is ensured and the guide shoe housing is also characterized by good dimensional stability and high mechanical and chemical stability.

The sliding element 7 is also made of an injection-moldable plastic material, wherein with regard to the sliding function, the plastic material for the sliding element 7 should be characterized by a low coefficient of friction. POM or UHMW-PE, for example, meets these requirements. The sliding element 7 could of course also be made of other suitable materials.

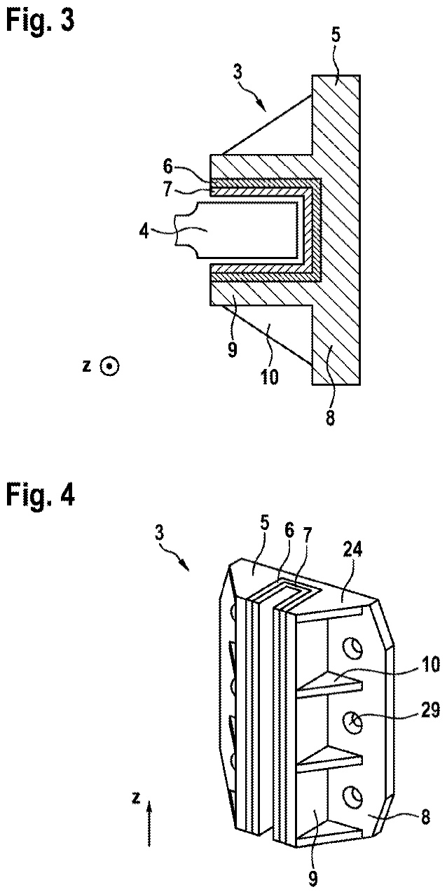

FIG. 3 shows a variant of a sliding guide shoe 3 in which, in addition, a damping element 6 is provided. The damping element 5 arranged between sliding element 7 and guide shoe housing 5 has the function of damping any noises and vibrations that may occur during car travel. The sliding guide shoe 3 is preferably a composite structure consisting entirely of plastic materials. The damping element 6 can be made of SBR, TUR, EPDM, NBR, NR, for example. From a production point of view, it is advantageous to use an elastic, injection-moldable plastic material, for example a thermoplastic elastomer (TPE), for the damping element 6.

The three substantial components of the sliding guide shoe 3, thus the guide shoe housing 5, the damping element 6 and the sliding element 7, are made of different plastic materials, depending on the intended function of the respective component, and are firmly bonded to each other. Such a sliding guide shoe 3 can be produced using a three-component injection molding process.

FIG. 4 shows a sliding guide shoe 3 in a perspective illustration which shows some constructional details. For example, it can be seen in FIG. 4 that the guide shoe housing has openings 29 for attachment to a bracket or directly to the car. As an example, there are three openings 29 arranged in the base portion 8, through which fastening screws, with which the guide shoe housing can be screwed to the car, can be inserted.

For safe and proper operation of the elevator, it may be necessary to wet the guide rails with oil or another lubricant. The guide rails are covered with a light film of oil as soon as the car moves. For this purpose, a lubrication attachment (not shown) can be used, which can be optionally attached to the guide shoe housing 5 in the region of the long side denoted by 24. However, instead of a lubrication attachment, other connecting elements would also be conceivable.

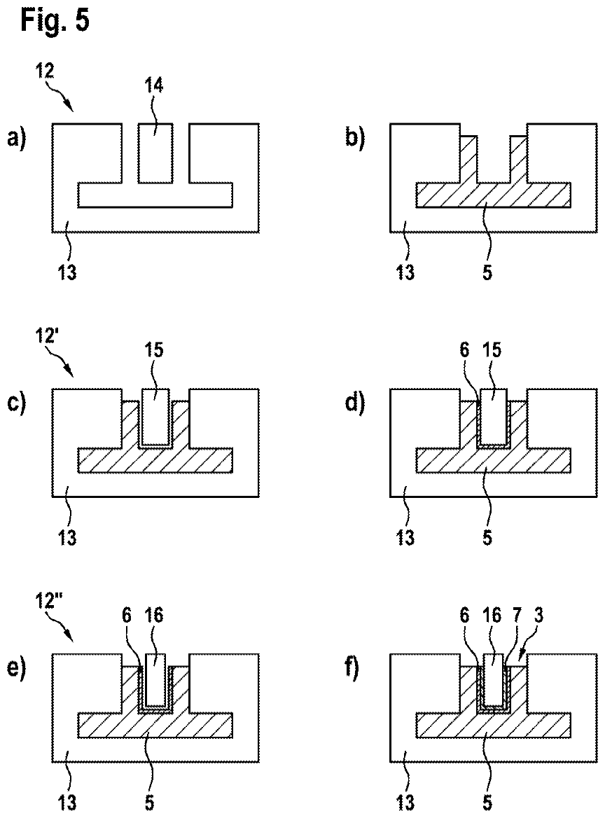

A process sequence for producing a sliding guide shoe according to the invention is shown in FIGS. 5 a-f. In a first step, the guide shoe housing is manufactured. A mold 12 is provided for this purpose (FIG. 5a). The mold 12 comprises a die 13 and a core 14. The die defines the outer contour of the guide shoe housing and can be configured in multiple parts for easy removal of the finished injection-molded part. The core 14 defines a channel-like receptacle in the guide shoe housing. Now, plastic material is injected in liquid form into the mold 12 to produce the guide shoe housing 5 (FIG. 5b). Thereafter, the core 14 is removed again from the die 13 and a second core 15 with narrower dimensions is inserted into the die 13 to prepare the mold 12′ (FIG. 5c). To form the one-piece composite structure for the sliding guide shoe, a second component, which can already be the sliding element or the damping element, can now be molded onto the guide shoe housing 5. For this purpose, a second plastic material is injected into the mold 12′. The second plastic material bonds with the first plastic material whereby a two-component molding consisting of the guide shoe housing 5 and the damping element 6 (FIG. 5d) is created. In this process step, the second plastic material is injection molded onto the guide shoe housing 5. Injection molding is preferably carried out when the blank for the guide shoe housing is still hot. However, it is also conceivable to injection mold the second plastic material only after the blank has cooled down partially or completely. Under certain circumstances, adhesive agents could be used in addition. Thereafter, the third component can be introduced. To do this, the core 15 is first removed from the die 13 and a narrower third core 16 is inserted into the die 13 to create the mold 12″ (FIG. 5e). This core 16 is substantially adapted to the guide rail (not shown here), taking into account the shrinkage behavior of the plastic material used and the desired play. A third plastic material is injected into the mold 12″ with die 13 and core 16. In this process step, the third plastic material is injection molded onto the damping element 6 to produce the sliding element 7. The third plastic material bonds with the second plastic material whereby finally a molding built from three components and consisting of the guide shoe housing 5, damping element 6 and sliding element 7 (FIG. 5f) is created. Injection molding is preferably carried out when the damping element 7 is still hot. However, it is also conceivable to injection mold the third plastic material only after the plastic material for the damping element 7 has cooled down partially or completely. Under certain circumstances, adhesive agents could also be used here.

The method described above is known as three-component injection molding process. The sliding guide shoe 3 produced in this way is a composite structure consisting entirely of plastic materials, wherein the guide shoe housing 5, the sliding element 6 and the damping element 7 are firmly bonded to each other, thus creating a compact, inexpensive, single-use sliding guide shoe that can be produced without assembly work. Since no separate elements have to be assembled manually or by machine, sliding guide shoes can be produced in large quantities in a simple and efficient manner. The method described is shortened for the sliding guide shoe which consists of only two components; the two-component sliding guide shoe is already finished after completion of the step according to FIG. 5d, wherein a suitable plastic material is selected as the second plastic material for forming the sliding element. The core 15 of the mold would in this case be adapted to the guide rail (cf. FIG. 5c).

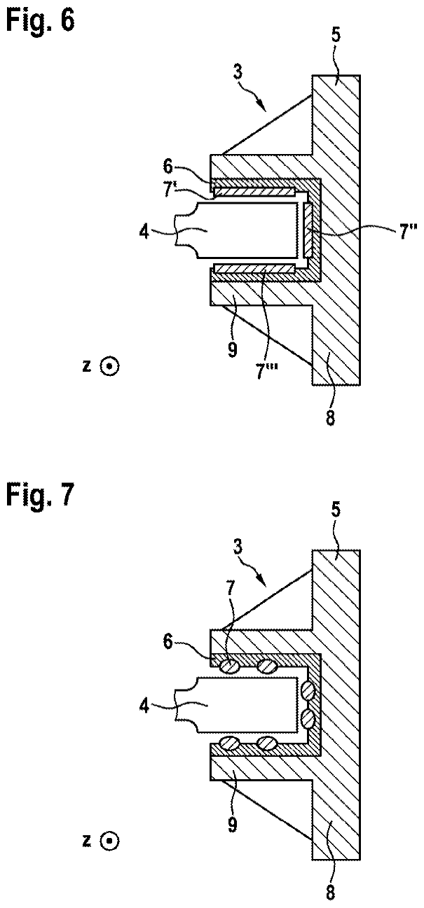

Depending on the materials used for the respective components (sliding element 7, damping element 6, guide shoe housing 5), a firmly bonded connection of the components is not or not sufficiently possible. Shrinkage can cause separating gaps between the components. For a safe connection of the components to each other, positive locking means must therefore be provided, whereby the guide shoe housing 5, the sliding element 7 and damping element 6 are positively connected to each other. Such a positive connection can be achieved by adapting the shape of the components. For this purpose, reference is made to the following FIGS. 6 to 11.

In the process sequence shown in FIG. 5 for producing the sliding guide shoe, the components are produced from the outside to the inside. In an alternative method for producing a sliding guide shoe according to the invention, the process sequence according to FIGS. 5a-f can take place in an analogous but reversed manner. In this case, first the sliding element 7 would thus be produced first by an injection molding process, then the damping element 6 would be injection molded onto the sliding element 7 and finally the guide shoe housing 5 would be injection molded onto the blank comprising sliding element 7 and damping element 6.

As can be seen in FIGS. 6 and 7, the sliding element 7 does not necessarily have to have a U-profile shape. As shown in FIG. 6, for example, the sliding element 7 could be formed in multiple parts and consist of three flat sub-elements 7′, 7″ and 7′″. Such sub-elements 7′, 7″ and 7′″ can also be easily produced by an injection molding process and connected to the rest of the sliding guide shoe. By injection molding onto the preferably still hot blank, it can be ensured that these individual elements 7 too are connected to the damping element 6 in a firmly bonded and thus captive manner.

Thanks to the two-component or three-component injection molding process, even more complicated shapes are possible. For example, as FIG. 7 shows, the sliding element 7 can be composed of a multiplicity of sub-elements, each of which has a curved cross-section, at least in certain sections.

The guide shoe housing 5 could have other shapes instead of the exemplary shape shown with the plate-like base portion 8 and the two walls projecting at right angles away from the base portion 8 and forming the support portions 9. By adapting the shape, it would also be possible to dispense with the ribs 10. Furthermore, it is conceivable, in particular for short guide shoe housings, to provide only one opening 29 on each side for a fastening screw. It would then be conceivable to configure the guide shoe housing 5 as a hollow body. The cavity of the hollow body could be used to receive oil for lubricating the guide rails.

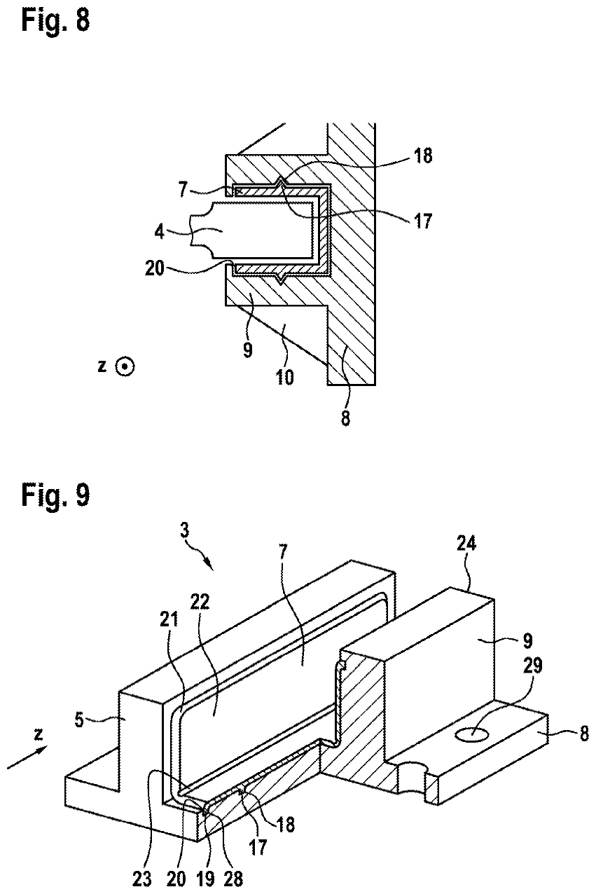

FIG. 8 shows a two-component sliding guide shoe 3, in which the sliding element 7 is positively received and secured in the guide shoe housing 5. For the positive connection, the sliding element 7 has a rib 17 which extends in the longitudinal direction z in the region of the underside and has a rib shape triangular in cross-section which engages in a complementary groove 18 in the guide shoe housing 5. Furthermore, the sliding element 7 is secured at the edge by a shoulder contour 20. Of course, other means of positive locking means than those shown here would also be conceivable. For example, instead of the elongated ribs 17 and grooves 18, positive locking means could also be provided at points in the interface between sliding element 7 and guide shoe housing 5. Positive locking means could be, for example, peg-like projections which are accommodated and engaged in complementary recesses.

In the exemplary embodiment according to FIG. 9, the sliding guide shoe 3 has a sliding element 7 with a circumferential positive locking collar 19, wherein the positive locking collar 19 engages in a positive locking groove 28 of the guide shoe housing 5. The outer edge of the groove 28 forms a circumferential shoulder contour 20 in the guide shoe housing 5, with which the sliding element is enclosed for securing at the edge. The circumferential positive locking collar 19 is also particularly clearly visible in FIG. 10. As is apparent from FIG. 9 and FIG. 10, the sliding element 7 comprises positive locking ribs 17 running transverse to the longitudinal direction z. These positive locking ribs 17 are accommodated in complementary grooves in the guide shoe housing 5. Furthermore, it can be seen that the sliding element 7 has a lead-in area 21 created by a chamfer or rounding, which offers advantages with regard to travel comfort and possible lubrication. Furthermore, FIG. 9 shows the sliding surfaces 22 associated with the sliding element 7, which, when the sliding guide shoe 3 is installed in the elevator and ready for use, slide along the guide rail with little play during car travel. The sliding surfaces 22 are obviously flat. In the corner regions between the sliding surfaces 22, which are perpendicular to each other, the sliding element 7 has undercuts 23 extending in the longitudinal direction z.

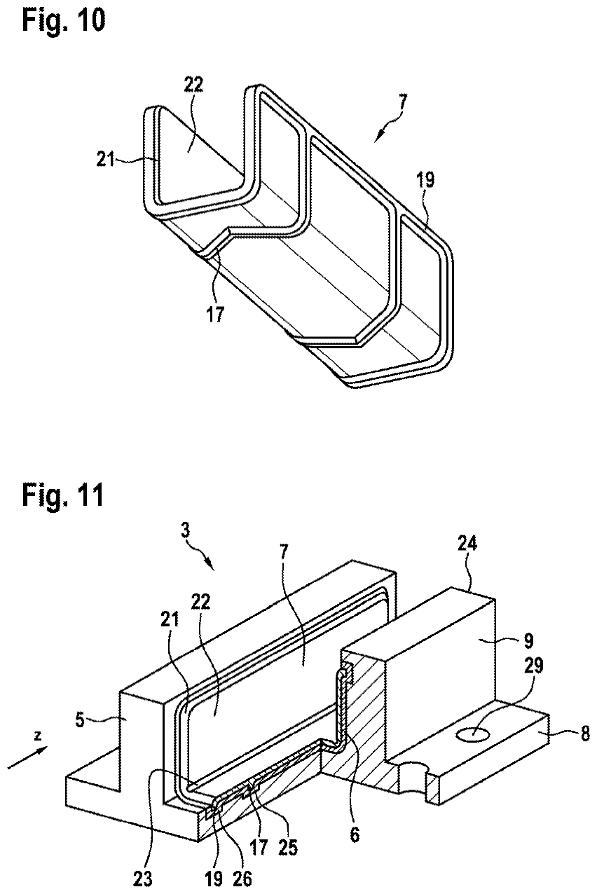

FIG. 11 shows a three-component sliding guide shoe 3, thus a sliding guide shoe 3 comprising guide shoe housing 5, sliding element 7 and damping element 6 arranged therebetween. The sliding element 7 is configured similarly to the sliding element according to the previous exemplary embodiment. However, in this case, the sliding element 7 is positively connected to the damping element 6. The damping element 6 is positively connected to the guide shoe housing 5. For this purpose, the damping element 6 has a comparatively wide circumferential positive locking collar 26 which is accommodated in a complementary positive locking groove in the guide shoe housing 5. Likewise, ribs 25 are molded onto the damping element 6 as further positive locking means.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A method for manufacturing a sliding guide shoe for an elevator, the method comprising the steps of:
providing a mold for producing a sliding guide shoe first component;
injecting a first plastic material into the mold thereby forming the first component either as a guide shoe housing or as a sliding element;
producing a composite structure by injection molding a second plastic material onto the first component thereby forming a sliding guide shoe second component on the first component, the second component being the sliding element or a damping element when the first component is the guide shoe housing, and the second component being the guide shoe housing or the damping element when the first component is the sliding element; and
when the second component is the damping element, completing the composite structure by molding a third plastic material onto the second component thereby forming a sliding guide shoe third component, the third component being the sliding element when the first component is the guide shoe housing, and the third component being the guide shoe housing when the first component is the sliding element.

2. The method according to claim 1 wherein at least two of the guide shoe housing, the sliding element and the damping element are made of different plastic materials.

3. The method according to claim 1 wherein the guide shoe housing includes a circumferential shoulder contour securing an edge of the sliding element.

4. The method according to claim 1 wherein the sliding element includes a circumferential positive locking collar engaging in a positive locking groove of the guide shoe housing.

5. The method according to claim 1 wherein the sliding element includes a plurality of sub-elements extending from faces of the sliding element proximal a guide rail along which the sliding guide shoe travels.

6. The method according to claim 1 wherein the sliding guide shoe is adapted for guiding an elevator car or a counterweight along a guide rail.

7. A method for manufacturing a sliding guide shoe for an elevator, the method comprising the steps of:
providing a mold for producing a guide shoe housing;
injecting a first plastic material into the mold thereby forming the guide shoe housing;
producing a composite structure by injection molding a second plastic material onto the guide shoe housing, the second plastic material thereby forming a sliding element or a damping element on the guide shoe housing; and
when the second plastic material forms the damping element, molding a third plastic material onto the damping element thereby forming the sliding element.

8. The method according to claim 7 wherein the damping element is included in the composite structure and wherein the guide shoe housing, the sliding element and the damping element are each made of different plastic materials.

9. The method according to claim 7 wherein at least two of the guide shoe housing, the sliding element and the damping element are made of different plastic materials.

10. The method according to claim 7 wherein the guide shoe housing includes a circumferential shoulder contour securing an edge of the sliding element.

11. The method according to claim 7 wherein the sliding element includes a circumferential positive locking collar engaging in a positive locking groove of the guide shoe housing.

12. The method according to claim 7 wherein the sliding element includes a plurality of sub-elements extending from faces of the sliding element proximal a guide rail along which the sliding guide shoe travels.

13. The method according to claim 7 wherein the sliding guide shoe is adapted for guiding an elevator car or a counterweight along a guide rail.

14. A method for manufacturing a sliding guide shoe for an elevator, the method comprising the steps of:
providing a mold for producing a sliding element;
injecting a first plastic material into the mold thereby forming the sliding element;
producing a composite structure by injection molding a second plastic material onto the sliding element, the second plastic material thereby forming a guide shoe housing or a damping element on the sliding element; and
when the second plastic material forms the damping element, molding a third plastic material onto the damping element thereby forming the guide shoe housing.

15. The method according to claim 14 wherein the damping element is included in the composite structure and wherein the guide shoe housing, the sliding element and the damping element are each made of different plastic materials.

16. The method according to claim 14 wherein at least two of the guide shoe housing, the sliding element and the damping element are made of different plastic materials.

17. The method according to claim 14 wherein the guide shoe housing includes a circumferential shoulder contour securing an edge of the sliding element.

18. The method according to claim 14 wherein the sliding element includes a circumferential positive locking collar engaging in a positive locking groove of the guide shoe housing.

19. The method according to claim 14 wherein the sliding element includes a plurality of sub-elements extending from faces of the sliding element proximal a guide rail along which the sliding guide shoe travels.

20. The method according to claim 14 wherein the sliding guide shoe is adapted for guiding an elevator car or a counterweight along a guide rail.
